(19) United States
(12) Patent Application Publication
(10) Pub. No.: US 2025/0350759 A1
(43) Pub. Date: Nov. 13, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Lei ZHAO, Beijing (CN); Li ZHANG, Los Angeles, CA (US); Kai ZHANG, Los Angeles, CA (US)

(21) Appl. No.: 19/278,523

(22) Filed: Jul. 23, 2025

Related U.S. Application Data
(63) Continuation of application No. PCT/CN2024/073657, filed on Jan. 23, 2024.

(30) Foreign Application Priority Data
Jan. 24, 2023 (WO) PCT/CN2023/073461

(51) Int. Cl. H04N 19/52; H04N 19/105; H04N 19/167; H04N 19/176

(52) U.S. Cl. CPC H04N 19/52; H04N 19/105; H04N 19/167; H04N 19/176

(57) ABSTRACT

Embodiments of the present disclosure provide a solution for video processing. A method for video processing is proposed. In the method, for a conversion between a current video block of a video and a bitstream of the video, a motion shift (MS) of the current video block is determined based on at least one indication in the bitstream. The MS comprises a vector associated with a location of a prediction of the current video block. Temporal motion information of the current video block is determined based on the MS. The conversion is performed based on the temporal motion information.

### CROSS REFERENCE TO RELATED APPLICATIONS

This application is a continuation of International Application No. PCT/CN2024/073657, filed on Jan. 23, 2024, which claims the benefit of International Application No. PCT/CN2023/073461 filed on Jan. 24, 2023. The entire contents of these applications are hereby incorporated by reference in their entireties.

### FIELDS

Embodiments of the present disclosure relate generally to video processing techniques, and more particularly, to motion shift (MS) for temporal motion information determination.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, a motion shift (MS) of the current video block based on at least one indication in the bitstream, the MS comprising a vector associated with a location of a prediction of the current video block; determining temporal motion information of the current video block based on the MS; and performing the conversion based on the temporal motion information. The method in accordance with the first aspect of the present disclosure determines the temporal motion information based on the indicated MS. The coding efficiency and coding effectiveness can thus be improved.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a motion shift (MS) of a current video block of the video based on at least one indication in the bitstream, the MS comprising a vector associated with a location of a prediction of the current video block; determining temporal motion information of the current video block based on the MS; and generating the bitstream based on the temporal motion information.

In a fifth aspect, a method for storing a bitstream of a video is proposed. The method comprises: determining a motion shift (MS) of a current video block of the video based on at least one indication in the bitstream, the MS comprising a vector associated with a location of a prediction of the current video block; determining temporal motion information of the current video block based on the MS; generating the bitstream based on the temporal motion information; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates motion vector scaling for temporal merge candidate;

FIG. 6 illustrates candidate positions for temporal merge candidate, C0 and C1;

FIG. 7 illustrates positions of non-adjacent candidate in ECM;

FIG. 8 illustrates MMVD search point;

FIG. 9 illustrates template matching performing on a search area around initial MV;

FIG. 10 illustrates a template and the corresponding reference template;

FIG. 11 illustrates a template and a reference template for block with sub=block motion using the motion information of the subblocks of current block;

FIG. 12 illustrates deriving sub-CU motion field obtained by applying a motion shift based on the neighboring motion information;

FIG. 13 illustrates a flowchart of a method for video processing in accordance with embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment.” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”. “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

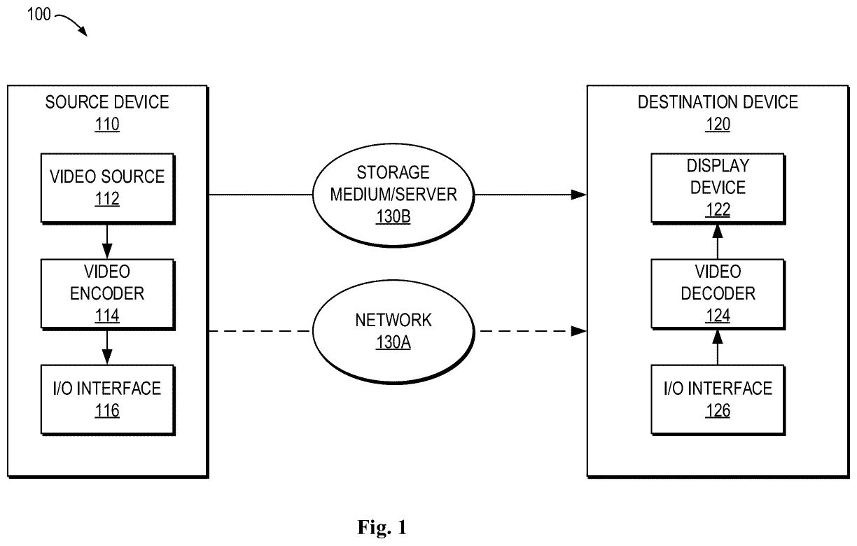

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

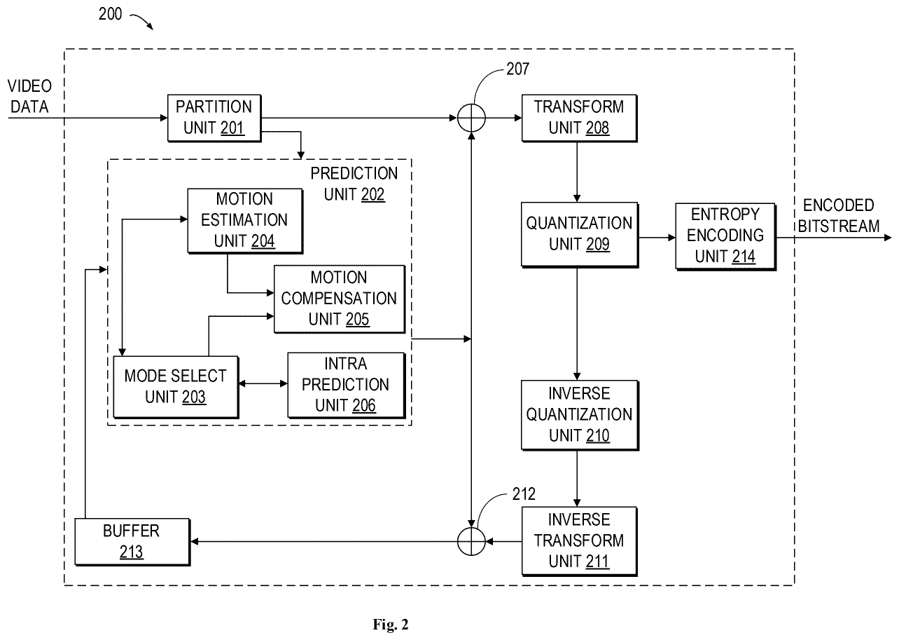

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 in may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

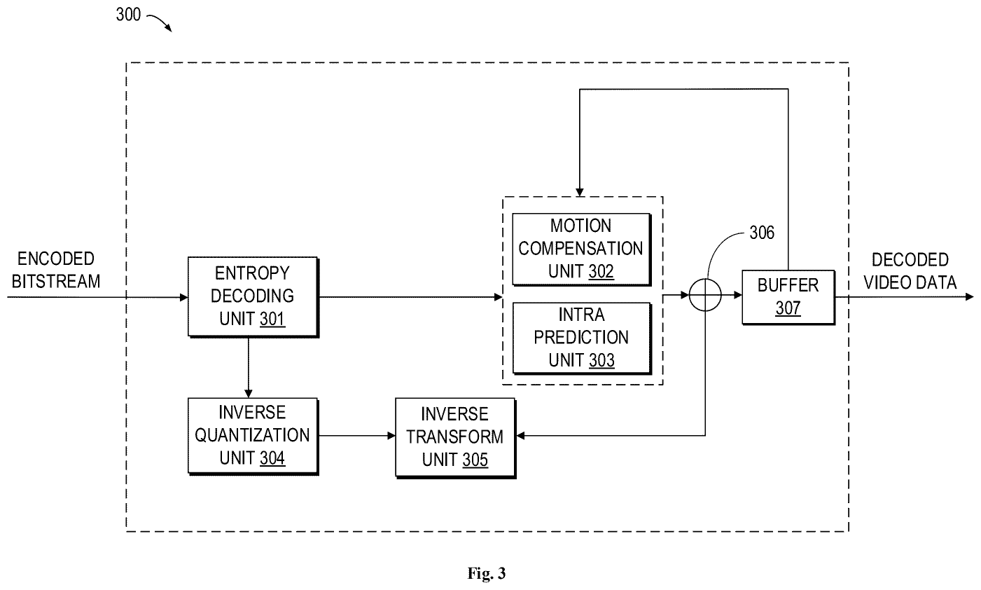

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video coding technologies. Specifically, it is about temporal motion vector prediction and related techniques in image/video coding. It may be applied to the existing video coding standard like HEVC, VVC, and etc. It may be also applicable to future video coding standards or video codec, e.g., ECM (Exploration Coding Model).

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.

### 2.1. MVP in Video Coding

### 2.1.1. AMVP and Merge Mode

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

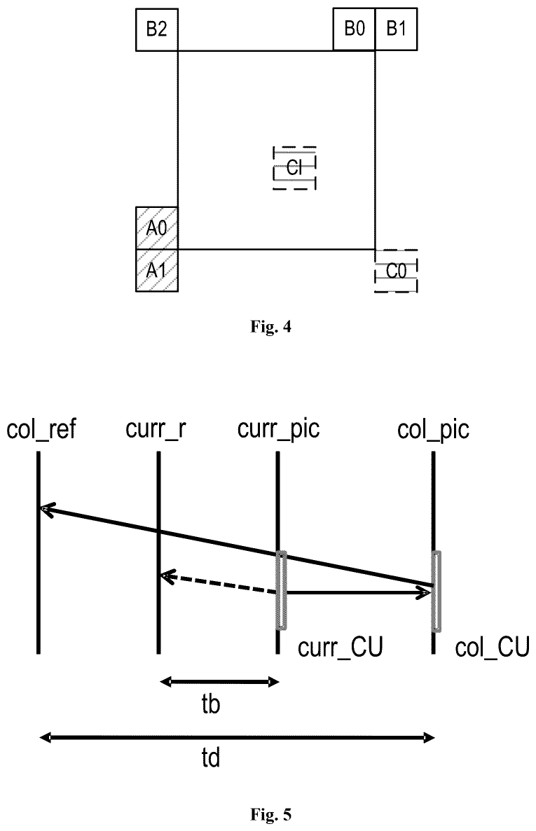

FIG. 4 illustrates positions of spatial and temporal neighboring blocks used in AMVP/merge candidate list construction.

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the merge candidate list is constructed by including the following five types of candidates in order:
1) Spatial MVP from spatial neighbour CUs,
2) Temporal MVP from collocated CUs,
3) History-based MVP from an FIFO table,
4) Pairwise average MVP,
5) Zero MVs.

FIG. 5 illustrates motion vector scaling for temporal merge candidate.

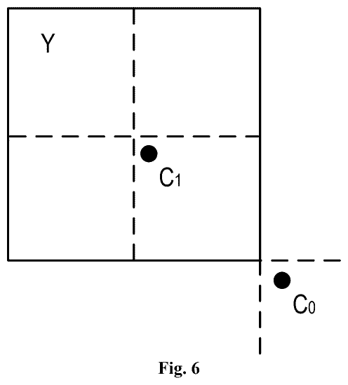

FIG. 6 illustrates candidate positions for temporal merge candidate, C0 and C1.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.1.1.1. Spatial Candidates Derivation

The derivation of spatial merge candidates in VVC is same to that in HEVC except the positions of first two merge candidates are swapped. A maximum of four merge candidates are selected among candidates located in the positions depicted in FIG. 4. The order of derivation is B1, A1, B0, A0 and B2. Position B2 is considered only when one or more than one CUs of position B1, A1, B0, A0 are not available (e.g. because it belongs to another slice or tile) or is intra coded. After candidate at position A1 is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check.

### 2.1.1.2. Temporal Candidates Derivation

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. The scaled motion vector for temporal merge candidate is obtained as illustrated by the dotted line in FIG. 5, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C₀ and C₁, as depicted in FIG. 6. If CU at position C₀ is not available, is intra coded, or is outside of the current row of CTUs, position C₁ is used. Otherwise, position C₀ is used in the derivation of the temporal merge candidate.

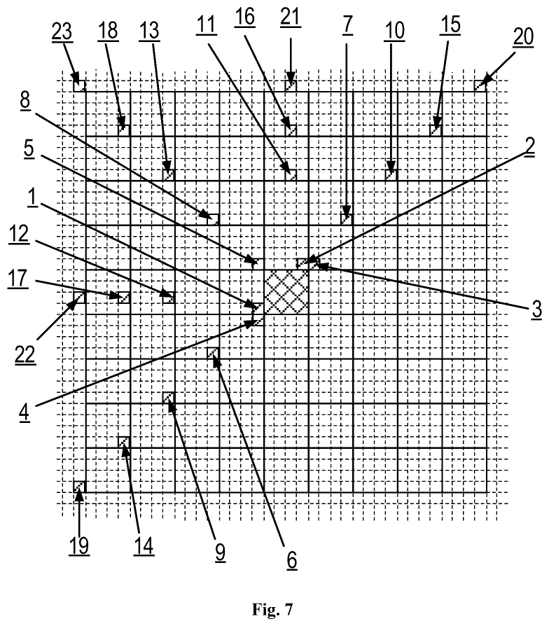

FIG. 7 illustrates positions of non-adjacent candidate in ECM.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 7.

### 2.1.2. Merge Mode with MVD (MMVD)

In addition to merge mode, where the implicitly derived motion information is directly used for prediction samples generation of the current CU, the merge mode with motion vector differences (MMVD) is introduced in VVC. A MMVD flag is signalled right after sending a skip flag and merge flag to specify whether MMVD mode is used for a CU.

In MMVD, after a merge candidate is selected, it is further refined by the signalled MVDs information. The further information includes a merge candidate flag, an index to specify motion magnitude, and an index for indication of motion direction. In MMVD mode, one for the first two candidates in the merge list is selected to be used as MV basis. The merge candidate flag is signalled to specify which one is used.

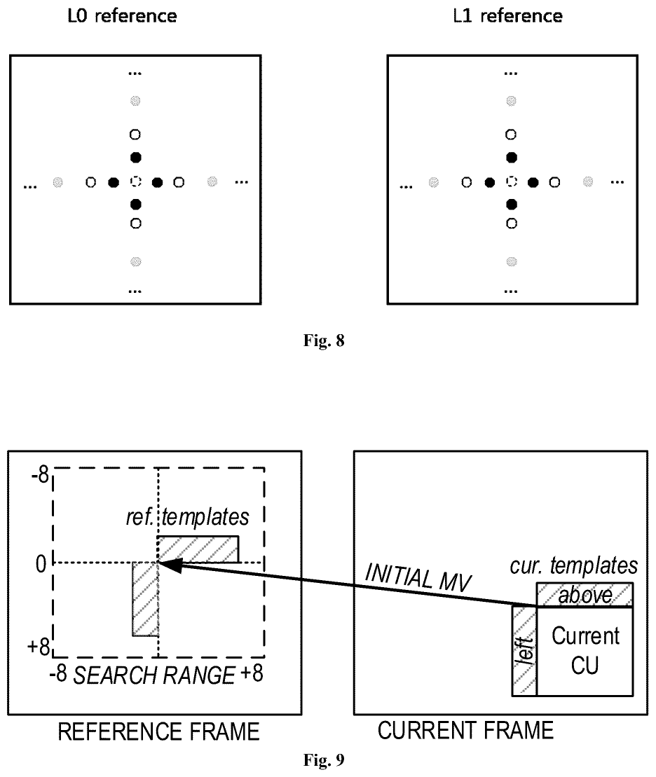

FIG. 8 illustrates MMVD search point.

Distance index specifies motion magnitude information and indicate the pre-defined offset from the starting point. As shown in FIG. 8, an offset is added to either horizontal component or vertical component of starting MV. The relation of distance index and pre-defined offset is specified in Table.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent of the four directions as shown in Table 2. It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign in Table 2 specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), the sign in Table 2 specifies the sign of MV offset added to the list0 MV component of starting MV and the sign for the list1 MV has opposite value.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### 2.1.3. Interpolation Filters in VVC

In VVC, interpolations filters are used in both intra and inter coding process. Intra coding takes advantage of interpolation filters to generate fractional positions in angular prediction modes. In HEVC, a two-tap linear interpolation filter has been used to generate the intra prediction block in the directional prediction modes (i.e., excluding Planar and DC predictors). While in VVC, four-tap intra interpolation filters are utilized to improve the angular intra prediction accuracy. In particular, two sets of 4-tap interpolation filters are utilized in VVC intra coding, which are DCT-based interpolation filter (DCTIF) and smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

In VVC, the highest precision of explicitly signaled motion vectors is quarter-luma-sample. In some inter prediction modes such as the affine mode, motion vectors are derived at 1/16th-luma-sample precision and motion compensated prediction is performed at 1/16th-sample-precision. VVC allows different MVD precision ranging from 1/16-luma-sample to 4-luma-sample. For half-luma-sample precision, 6-tap interpolation filter is used. While for other fractional precisions, default 8-tap filter is used. Besides, the bilinear interpolation filter is used to generate the fractional samples for the searching process of decoder side motion vector refinement (DMVR) in VVC.

### 2.1.4. Template Matching Merge/AMVP Mode in ECM

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. As illustrated in FIG. 9, a better MV is to be searched around the initial motion of the current CU within a [−8, +8]-pel search range.

FIG. 9 illustrates template matching performing on a search area around initial MV.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.1.5. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

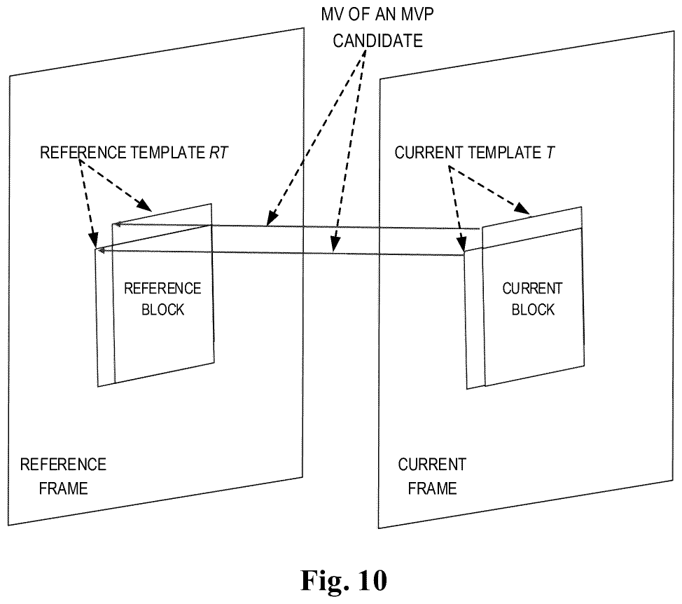

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered. The template matching cost is measured by the sum of absolute differences (SAD) between samples of a template of the current block and their corresponding reference template. The template comprises a set of reconstructed samples neighboring to the current block, while reference template is located by the same motion information of the current block, as illustrated in FIG. 10. When a merge candidate utilizes bi-directional prediction, the reference samples of the template of the merge candidate are also generated by bi-prediction.

FIG. 10 illustrates template and the corresponding reference template.

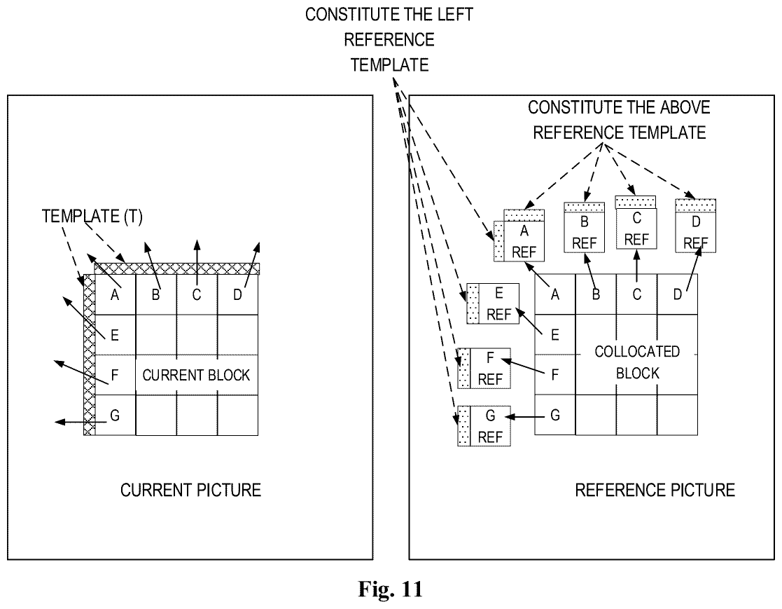

FIG. 11 illustrates template and reference template for block with sub-block motion using the motion information of the subblocks of current block.

For subblock-based merge candidates with subblock size equal to Wsub*Hsub, the above template comprises several sub-templates with the size of Wsub×1, and the left template comprises several sub-templates with the size of 1×Hsub. As shown in FIG. 11. the motion information of the subblocks in the first row and the first column of current block is used to derive the reference samples of each sub-template.

### 2.1.6. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTVMP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU.

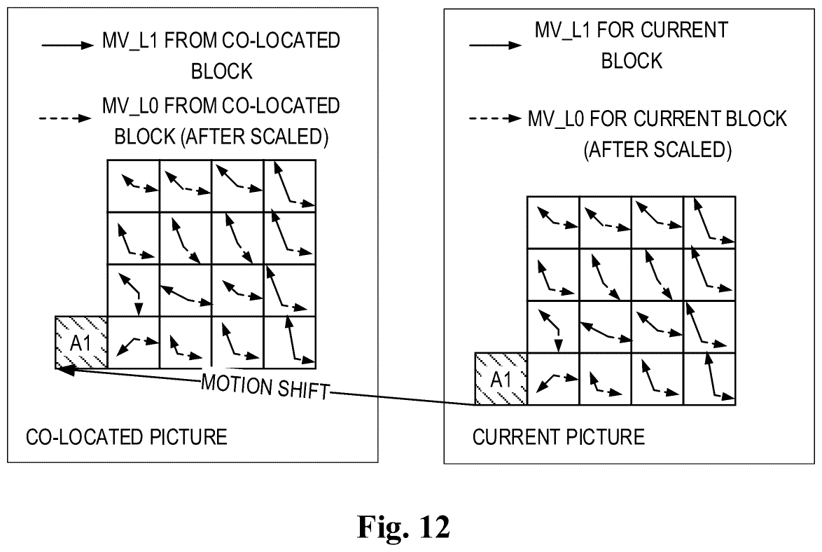

FIG. 12 illustrates the derivation process of the sub-block level motion field for SbTMVP. In particular, the motion information of left-bottom sub-block A1 is firstly fetched, if either of the MVs in reference list0 and list1 points to the collocated picture, then the corresponding MV will be identified as motion shift. Otherwise, zero mv will be used as motion shift.

Once the motion shift is determined, the specified regions in the collocated picture is employed to derive sub-block level motion field. Assuming A1′ motion is used as motion shift as depicted in FIG. 12. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

FIG. 12 illustrates deriving sub-CU motion field obtained by applying a motion shift based on the neighboring motion information.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.1.7. Collocated Picture and TMVP Candidate List in ECM-5.0

In ECM-5.0, only one collocated picture is utilized to provide TMVP that are required in the MVP list construction process, which is derived from the reference frame list. In particular, if only one reference list is maintained in the coding process, then the reference frame with index zero is utilized as collocated picture. Otherwise, if the to-be-coded frame has two reference frame lists as in random access and low-delay B configurations, the quantization parameter (QP) value of the reference frame with index zero in both lists are compared, and the one with larger QP will be chosen as collocated picture for the current frame.

For regular merge and adaptive DMVR modes in ECM-5.0, the derivation of the TMVP in the ultimate MVP list is further optimized, where TMVP candidate list is first constructed to include the TMVPs that locate in different positions within the collocated picture. Specifically, both adjacent and non-adjacent positions in the right-bottom direction are used to provided multiple TMVP candidates. When TMVP list is constructed, templated matching cost is calculated for each candidate and the list is accordingly sorted in a descending order of such cost. Finally, the candidate with the least template matching cost will be inserted in the ultimate MVP list. Regarding TMVP derivation for AMVP and AFFINE mode, no TMVP list is needed and only one TMVP is derived based on two different collocated positions (bottom-right (C0) and central (C1)) checked in order.

### 3. PROBLEMS

There are several issues in the existing video coding techniques, which would be further improved for higher coding gain.
1. In VVC and ECM, only the TMVPs from some fixed locations are utilized, while the TMVPs from other locations may provide better prediction.
2. How to efficiently identify the TMVP locations may be further specified.

### 4. DETAILED SOLUTIONS

The detailed embodiments below should be considered as examples to explain general concepts. These embodiments should not be interpreted in a narrow way. Furthermore, these embodiments can be combined in any manner.

The term ‘TMVP’ may represent a MVP collected from certain collocated position in a temporally already reconstructed frame/picture/region, which may indicate that involved in any prediction mode or coding technique, including but not limited to MODE_INTER, AMVP, AMVP-merge, adaptive DMVR, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, and the corresponding variants, and etc. The term “motion shift (MS)” represent a MV that can be used to identify the location of a TMVP or SbTMVP. The term “motion shift prediction (MSP)” may represent a MV that can be used to predict MS. The term “motion shift difference (MSD)” may represent the difference between an MS and an MSP.

The terms “video unit” or ‘coding unit’ or ‘block’ may represent a coding tree block (CTB), a coding tree unit (CTU), a coding block (CB), a CU, a PU, a TU, a PB, a TB.

It is noted that the terminologies mentioned below are not limited to the specific ones defined in existing standards. Any variance of the coding tool is also applicable.
1. Instead of using fixed MS to derive temporal motion information, indication of the MS may be signalled in the bitstream.
   a. In one example, an MS difference between the final MS and its predictor may be signalled.
   b. In one example, multiple MSD candidates may be derived.
      i. Alternatively, furthermore, an index of the MSD candidates may be signalled, and the MSD associated with the signalled index and a predictor may be utilized for current block.
      ii. Alternatively, furthermore, an index of the MSD candidates may be signalled, and the MSD associated with the signalled index may be firstly converted to a final MSD (e.g., shifting, scaling), the final MSD together with a predictor may be utilized for current block.
      iii. Alternatively, furthermore, in above sub-bullets, the predictor may be further derived/defined/signalled.
   c. In one example, multiple MS candidates may be derived.
      i. Alternatively, furthermore, an index of MS candidates may be signalled, and the MS candidate associated with the signalled index may be utilized for current block.
      ii. Alternatively, furthermore, an index of MS candidates may be signalled, and the MS candidate associated with the signalled index may be firstly converted to a final MS (e.g., shifting, scaling) and the final MS may be utilized for current block.
   d. In one example, multiple MSPs may be derived.
      i. Alternatively, furthermore, an index of the MSPs may be signalled, and the MSP associated with the signalled index and an MSD may be utilized for current block.
      ii. Alternatively, furthermore, an index of MSPs may be signalled, and the MSP associated with the signalled index may be firstly converted to a final MS predictor (e.g., shifting, scaling), the final MS predictor together with an MSD may be utilized for current block.
      iii. Alternatively, furthermore, in above sub-bullets, the MSD may be further derived/defined/signalled.
   e. In one example, multiple TMVP candidates with different MSs may be put into a candidate list.
      i. The candidate list may be a merge candidate list.
      ii. The candidate list may be a sub-block-based merge candidate list.
      iii. The candidate list may be an AMVP candidate list.
2. In one example, a history table with stored MSP associated with previously coded blocks may be maintained and/or updated on-the-fly.
3. An MSP list may be constructed to provide one or multiple MSP candidate(s).
   a. In one example, an MSP candidate corresponds to the MV of a specific location, which may be collected from adjacent and/or non-adjacent locations of the current block.
      1). In one example, an MSP candidate may be collected from HMVP.
      ii. In one example, an MSP candidate may be a zero MV.
   b. In one example, the MSP candidates are checked and/or included into the MSP list in a pre-defined order.
      i. In one example, adjacent candidates are checked before non-adjacent candidates.
      ii. In one example, the checking order is in accordance with the distance relative to the corresponding locations.
         1). In one example, a location with less distance relative to the current location has higher priority to be checked and/or included in the MSP list.
      iii. In one example, the checking process terminates when the number of available candidates reaches the maximum allowed value.
c. In one example, multiple MSP lists may be constructed for a block.
   i. In one example, an MSP list is constructed for each reference picture list.
   ii. In one example, an MSP list is constructed for each of reference picture which is used to derive temporal motion information (e.g., for each collocated picture).
      1). In one example, an MSP list is constructed for only partial collocated pictures.
   iii. In one example, when constructing the MSP list for i-th collocated picture, only the MSPs that points to the corresponding collocated picture can be included in this MSP list.
      1). In one example, even if an MSP does not point to i-th collocated picture, it may still be included in the corresponding MSP list after it is scaled to the i-th collocated picture.
   iv. In one example, only one MSP list is constructed, and an MSP candidate may be included in the list as long as it points to any one of the collocated pictures.
d. In one example, the MSP list may be constructed by reusing or reforming the merge and/or AMVP candidate list.
   i. In one example, the candidates in merge or AMVP list are checked in order, which will be included in MSP list if satisfies certain conditions.
      1). In one example, a candidate will be included in MSP list if it points to any or specific one of the collocated picture.
e. In one example, the MSP list is constructed along with pruning operation.
f. In one example, an MSP list comprises a fixed number (i.e., N, where N is a constant) of candidate.
   i. In one example, after checking adjacent and/or non-adjacent and/or HMVP, if the number of the available candidates in the list does not reach N, then virtual candidates are included to pad the MSP list.
      1). In one example, the virtual candidate may be zero or arbitrary candidates.
4. The aforementioned MSP/MSD candidate list may be a merge candidate list.
5. The aforementioned MSP/MSD candidate list may be a sub-block-based merge candidate list.
6. The aforementioned MSP/MSD candidate list may be an AMVP candidate list.
7. After an MSP list is constructed, it may be further reordered according to certain cost, i.e., template matching cost.
8. An MSP index may be signalled to specify the chosen candidate in MSP list.
   a. In one example, alternatively, no MSP index is signalled.
      i. In one example, the MV in a fixed location LMSP is used as MSP.
         1). In one example, if the MV in the fixed location is not available or does not satisfy certain condition, then zero MV is used instead.
         2). In one example, the MV may be scaled before used as MSP.
      ii. In one example, the MVs in adjacent and/or non-adjacent, and/or HMVP, and/or the candidates in merge/AMVP list are checked in order, the first candidate which satisfies certain condition will directly be used as MSP.
         1). In one example, the first available candidate that points to any or arbitrary collocated picture is selected.
         2). In one example, if all the locations/candidates are checked and no MSP is selected, then zero MV may be used as MSP.
         3). In one example, specifically, no MSP index is signalled in this case.
9. MSD may be signalled to refine MSP.
   a. In one example, k-pel (where k is an integer larger than 0) precision may be used to signal MSD.
      i. In one example, alternatively, fractional precision may be used to signal MSD.
   b. In one example, if TMVP/SbTMVP is used, MS is generated by refine MSP with MSD.
10. One or multiple index(es) indicating which MSD is used may be signalled, in a similar way as MMVD.
   a. In one example, MSD may only be allowed to be selected from a fixed MSD set.
   b. In one example, each candidate in the MSD set may be identified by distance index and/or direction index.
      i. In one example, specifically, distance index specifies motion magnitude information and indicates the pre-defined offset from the MSP.
         1). In one example, the specified offset may be added to either horizontal component or vertical component of MSP.
      ii. In one example, direction index represents the direction of the MSD relative to the starting point.
         1). In one example, the direction index can represent k (i.e., k=4) directions.
   c. In one example, before the index is used to specify MSD, the distance index and/or direction index may also be reordered based on certain cost, i.e., template matching cost.
11. Whether MSD (or distance/direction indexes of MSD) is signalled may depend on the coding mode.
   a. In one example, MSD (or distance/direction indexes of MSD) only need to be signalled in AMVP mode.
   b. In one example, alternatively, MSD (or distance/direction indexes of MSD) only need to be signalled in merge mode.
   c. In one example, alternatively, MSD (or distance/direction indexes of MSD) may need to be signalled in merge and AMVP mode.
12. If MSD (or distance/direction indexes of MSD) is signalled, the motion vector difference (MVD) may no longer need to be signalled.
   a. In one example, alternatively, if MVD is signalled, MSD (or distance/direction indexes of MSD) may no longer need to be signalled.
   b. In one example, alternatively, MVD and MSD (or distance/direction indexes of MSD) may need to be simultaneously signalled for a block.
13. A first MS candidate may be compared with a second MS candidate before it is put into a list.
   a. In one example, the first MS candidate is not put into the list if it is determined to be same or similar to the second MS candidate.
      i. In one example, the first MS candidate is determined to be same or similar to the second MS candidate if the two motions shifts are same or the difference of the two motions shifts is lower than a threshold.
      ii. In one example, the first MS candidate is determined to be same or similar to the second MS candidate if the blocks referred by the two motion shifts contain the same or similar motion information.
14. The MSP index, and/or MSD (or distance/direction indexes of MSD) may be coded with truncated Rice (TR) code, the truncated binary (TB) code, the k-th order Exp-Golomb (EGk) code or the fixed-length (FL) code.
15. Whether to and/or how to apply the disclosed methods above may be determined based on syntax element(s).
   a. For example, at least one syntax element is signalled in the bitstream.
   b. For example, whether to and/or how to apply the disclosed methods may be signalled at sequence level/group of pictures level/picture level/slice level/tile group level, such as in sequence header/picture header/SPS/VPS/DPS/DCI/PPS/APS/slice header/tile group header.
   c. For example, whether to and/or how to apply the disclosed methods may be signalled at PB/TB/CB/PU/TU/CU/VPDU/CTU/CTU row/slice/tile/sub-picture/other kinds of region contain more than one sample or pixel.
   d. For example, whether to and/or how to apply the disclosed methods above may be dependent on coded information, such as coding tool, block size, colour format, single/dual tree partitioning, colour component, slice/picture type.
   e. For example, whether a syntax element (MSP index, MSD (or distance/direction indexes of MSD)) is signalled or not may be determined based on another syntax element.
16. The disclosed methods can be applied to TMVP and/or SbTMVP, and/or any other temporal motion information derivation.
17. The proposed methods aforementioned may be applied to intra-block copy merge/AMVP mode, to fetch block vector(s).

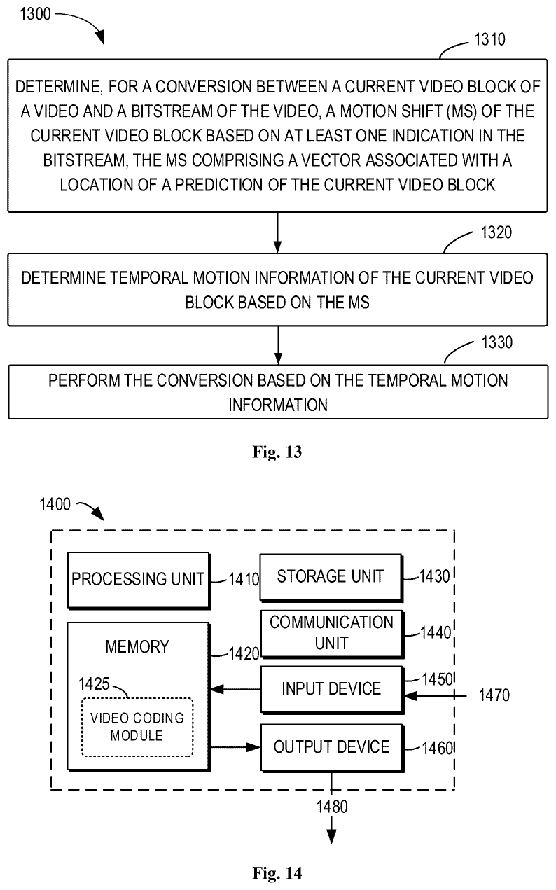

Further details will be described below. FIG. 13 illustrates a flowchart of a method 1300 for video processing in accordance with embodiments of the present disclosure. The method 1300 is implemented for a conversion between a current video block of the video and a bitstream of the video.

At block 1310, a motion shift (MS) of the current video block is determined based on at least one indication in the bitstream. The MS comprises a vector associated with a location of a prediction of the current video block. For example, the vector may be a motion vector (MV) or a block vector (BV). For example, the MS may represent an MV that may be used to identify the location of a temporal motion vector prediction (TMVP) or subblock-based TMVP (SbTMVP).

At block 1320, temporal motion information of the current video block is determined based on the MS.

At block 1330 the conversion is performed based on the temporal motion information. In some embodiments, the conversion includes encoding the current video block into the bitstream. Alternatively, or in addition, the conversion includes decoding the current video block from the bitstream.

The method 1300 enables deriving the temporal motion information based on MS of the current video block. The MS may be indicated in the bitstream. By using the indicated MS instead of the fixed MS, a higher coding gain can be achieved. The coding efficiency and/or coding effectiveness can thus be improved.

In some embodiments, determining the MS comprises: determining a motion shift prediction (MSP) and a motion shift difference (MSD) of the current video block based on the at least one indication; and determining the MS based on the MSP and the MSD. As used herein, the determined MS may be referred to as a final MS.

In some embodiments, the at least one indication comprises an indication of the MSD, the MSD being a difference between the MS and a predictor of the MS. MSD may be signaled to refine MSP.

In some embodiments, the indication of the MSD is included in the bitstream based on one of: an integer-pel precision, or a fractional precision. For example, k-pel (k being an integer larger than 0) precision or fractional precision may be used to signal MSD.

In some embodiments, at least one of: a temporal motion vector prediction (TMVP) or a subblock-based TMVP (SbTMVP) is applied to the current video block, and the MS is determined by refining the MSP with the MSD, the MS comprising a motion vector (MV) to locate a location of a TMVP or an SbTMVP of the current video block. That is, if TMVP or SbTMVP is used, MS is generated by refine MSP with MSD.

In some embodiments, the at least one indication comprises at least one index indicating the MSD. For example, one or multiple index(es) indicating which MSD is used may be signalled, in a similar way as MMVD.

In some embodiments, the MSD is selected from an MSD set based on the at least one index, the MSD set comprising at least one MSD candidate. For example, the MSD set may be fixed.

In some embodiments, a candidate in the MSD set is associated with at least one of: a distance index or a direction index. For example, each candidate in the MSD set may be identified by distance index and/or direction index.

In some embodiments, the distance index of the candidate comprises motion magnitude information of the candidate and indicates an offset from the MSP. For example, the distance index may specify motion magnitude information and indicate a predefined offset from the MSP.

In some embodiments, the offset is added to at least one of: a horizontal component of the MSP, or a vertical component of the MSP. For example, the predefined offset may be added to either horizontal component or vertical component of MSP.

In some embodiments, the direction index indicates a direction of the candidate of the MSD relative to a starting point corresponding to the MSP. In one example, direction index may represent the direction of the MSD relative to the starting point.

In some embodiments, the direction index indicates at least one direction in a plurality of directions. For example, the number of the plurality of directions is four. The direction index may represent k (for example, k=4) directions.

In some embodiments, the MSD set comprises a plurality of MSD candidates with a plurality of indexes. The plurality of indexes may be reordered based on template matching costs. The plurality of indexes may be a plurality of distance indexed or a plurality of direction indexes.

In some embodiments, determining the MS comprises: determining a plurality of motion shift difference (MSD) candidates of the current video block; determining an MSD based on the plurality of MSD candidates; and determining the MS based on the MSD.

In some embodiments, the at least one indication comprises an index of a target MSD candidate in the plurality of MSD candidates, the MSD being determined based on the target MSD candidate.

In some embodiments, the MSD is the target MSD candidate.

In some embodiments, the MSD is determined by applying at least one of a shifting or a scaling to the target MSD candidate.

In some embodiments, the MS is determined based on the MSD and a predictor of the MS.

In some embodiments, the predictor of the MS is determined during the conversion.

In some embodiments, the predictor of the MS is defined.

In some embodiments, the predictor of the MS is included in the bitstream.

In some embodiments, the at least one indication comprises an index of an MS candidate, and determining the MS based on the at least one indication comprises: determining the MS from a plurality of MS candidates based on the index.

In some embodiments, the MS for the current video block is the MS candidate associated with the index.

In some embodiments, the MS for the current video block is determined by applying at least one of a shifting or a scaling to the MS candidate associated with the index.

In some embodiments, determining the MS comprises: determining a plurality of motion shift prediction (MSP) candidates of the current video block; determining an MSP based on the plurality of MSP candidates; and determining the MS based on the MSP.

In some embodiments, the at least one indication comprises an index of a target MSP candidate in the plurality of MSP candidates, the MSP being determined based on the target MSP candidate.

In some embodiments, the MSP is the target MSP candidate.

In some embodiments, the MSP is determined by applying at least one of a shifting or a scaling to the target MSP candidate.

In some embodiments, the MS is determined based on the MSP and a motion shift difference (MSD).

In some embodiments, the MSD is determined during the conversion.

In some embodiments, the MSD is defined.

In some embodiments, the MSD is included in the bitstream.

In some embodiments, a history table of stored motion shift predictions (MSPs) of at least one previously coded block of the video is maintained.

In some embodiments, a history table of stored motion shift predictions (MSPs) of at least one previously coded block of the video is updated on-the-fly.

In some embodiments, the method 1300 further comprises: determining at least one motion shift prediction (MSP) list comprising at least one MSP candidate, the MS of the current video block being determined based on the at least one MSP list.

In some embodiments, an MSP candidate in the at least one MSP list comprises a vector associated with a location, the vector being collected from at least one of: an adjacent location of the current video block, or a non-adjacent location of the current video block.

In some embodiments, the vector comprises one of: a motion vector (MV) or a block vector (BV).

In some embodiments, the MSP candidate is collected from a history-based motion vector prediction (HMVP) of the current video block.

In some embodiments, a plurality of MSP candidates is checked in a predefined order to be included in an MSP list of the at least one MSP list.

In some embodiments, an adjacent candidate is checked before a non-adjacent candidate.

In some embodiments, the predefined order is based on distances relative to corresponding locations of the MSP candidates.

In some embodiments, a location with a corresponding location less than a current location of the current video block has a priority higher than a threshold priority.

In some embodiments, the checking terminates if the number of available candidates in the MSP candidate list reaches a threshold number.

In some embodiments, the at least one MSP list comprises a plurality of MSP lists.

In some embodiments, the plurality of MSP lists comprises a respective MSP list for each of at least one reference picture list.

In some embodiments, the plurality of MSP lists comprises at least one MSP list for at least one reference picture, the temporal motion information of the current video block being determined based on the at least one reference picture.

In some embodiments, the at least one reference picture corresponds to at least one collocated picture of the current video block.

In some embodiments, the at least one reference picture comprises a plurality of reference pictures, and the plurality of MSP lists comprises respective MSP lists of the plurality of reference pictures.

In some embodiments, the at least one reference picture comprises a plurality of reference pictures corresponding to a plurality of collocated pictures of the current video block. The plurality of MSP lists comprises at least one MSP list associated with at least one collocated picture of the plurality of collocated pictures.

In some embodiments, for a collocated picture of a plurality of collocated pictures of the current video block, an MSP list corresponding to the collocated picture comprises at least one MSP pointing to the collocated picture.

In some embodiments, an MSP does not point to the collocated picture, a scaled MSP scaling from the MSP is included in the MSP list if the scaled MSP points to the collocated picture.

In some embodiments, the at least one MSP list comprises a single MSP list, at least one MSP candidate pointing to one of a plurality of collocated pictures of the current video block is included in the single MSP list.

In some embodiments, the at least one MSP list is determined based on at least one of: a merge candidate list, or an advanced motion vector prediction (AMVP) candidate list.

In some embodiments, candidates in at least one of the merge candidate list or the AMVP candidate list are checked in order based on at least one condition.

In some embodiments, the at least one condition comprises a condition that a candidate points to at least one collocated picture of the current video block, and if the condition is satisfied, the candidate is included in the at least one MSP list.

In some embodiments, the at least one MSP list is determined based on a pruning process.

In some embodiments, the number of candidates in an MSP list of the at least one MSP list is fixed.

In some embodiments, after checking at least one of: an adjacent candidate, a non-adjacent candidate or a history-based motion vector prediction (HMVP) candidate, if the number of available candidates in the MSP list is less than the fixed number, at least one virtual candidate is included to pad the MSP list.

In some embodiments, the at least one virtual candidate comprises at least one of: a zero candidate, or a further candidate.

In some embodiments, the at least one MSP list is reordered based on a cost. For example, the cost may be a template matching cost.

In some embodiments, the at least one indication comprises an index of a motion shift prediction (MSP) in an MSP list, the MS of the current video block being determined based on the MSP associated with the index.

In some embodiments, an index of a motion shift prediction (MSP) in an MSP list is not included in the bitstream.

In some embodiments, an MSP is determined based on a motion vector in a fixed location, the MS of the current video block being determined based on the MSP.

In some embodiments, if the motion vector in the fixed location is unavailable or does not satisfy a condition, the MSP is determined to be a zero motion vector.

In some embodiments, the MSP is determined by scaling the motion vector.

In some embodiments, the MS of the current video block is determined based on an MSP, the MSP being determined by checking at least one of: a motion vector in an adjacent candidate, a motion vector in a non-adjacent candidate, a history-based motion vector prediction (HMVP), a candidate in a merge candidate list, or a candidate in an advanced motion vector prediction (AMVP) candidate list.

In some embodiments, a first candidate satisfying at least one condition during the checking is determined as the MSP.

In some embodiments, no candidate satisfies at least one condition during the checking, and the MSP is determined to be a zero motion vector.

In some embodiments, a motion shift prediction (MSP) candidate list of the current video block comprises at least one of: a merge candidate list, a subblock-based merge candidate list, or an advanced motion vector prediction (AMVP) candidate list.

In some embodiments, a motion shift difference (MSD) candidate list of the current video block comprises at least one of: a merge candidate list, a subblock-based merge candidate list, or an advanced motion vector prediction (AMVP) candidate list.

In some embodiments, whether an indication of a motion shift difference (MSD) is included in the bitstream is based on a coding mode of the current video block.

In some embodiments, the indication of the MSD comprises at least one of: a distance index of the MSD, or a direction index of the MSD.

In some embodiments, the coding mode comprises at least one of: a merge mode or an advanced motion vector prediction (AMVP) mode, and the indication of the MSD is included in the bitstream.

In some embodiments, the indication of the MSD is included in the bitstream, and a motion vector difference (MVD) is not included in the bitstream.

In some embodiments, a motion vector difference (MVD) is included in the bitstream, and the indication of the MSD is not included in the bitstream.

In some embodiments, a motion vector difference (MVD) and the indication of the MSD are included in the bitstream simultaneously for the current video block.

In some embodiments, a first MS candidate is added into the list of MS candidates based on a comparison with a second MS candidate. For example, the first MS candidate may be compared with the second MS candidate before it is put into the list.

In some embodiments, if a difference between the first MS candidate and the second MS candidate is less than or equal to a threshold, the first MS candidate is not added into the list of MS candidates.

In some embodiments, if a difference between first motion information in a first block referred by the first MS candidate and second motion information in a second block referred by the second MS candidate is less than or equal to a threshold, the first MS candidate is not added into the list of MS candidates.

In some embodiments, the at least one indication in the bitstream is coded by at least one of: a truncated rice (TR) code, a truncated binary (TB) code, a k-th order exponential-Golomb (EGk) code, or a fixed-length (FL) code, wherein the at least one indication comprises at least one of: an index of a motion shift prediction (MSP) of the current video block, or an index of a motion shift difference (MSD) of the current video block.

In some embodiments, the method 1300 is applied to at least one of: a temporal motion vector prediction (TMVP), a subblock-based TMVP (SbTMVP), or a temporal motion information derivation, and wherein the vector comprised in the MS comprises a motion vector. For example, the method 1300 may be applied to TMVP and/or SbTMVP, and/or any other temporal motion information derivation.

In some embodiments, the method 1300 is applied to at least one of: an intra block copy (IBC) merge mode, or an IBC advanced motion vector prediction (AMVP) mode, and wherein the vector comprised in the MS comprises a block vector. That is, the method 1300 may be applied to IBC merge/AMVP mode, to fetch block vector(s).

In some embodiments, whether to and/or how to apply the method 1300 is based on at least one syntax element.

In some embodiments, the at least one syntax element is included in the bitstream.

In some embodiments, the at least one syntax element is included at at least one of: a sequence level, a group of pictures level, a picture level, a slice level, or a tile group level.

In some embodiments, the at least one syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

In some embodiments, the at least one syntax element is included in a region containing more than one sample or pixel.

In some embodiments, the region comprises at least one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

In some embodiments, whether to and/or how to apply the method 1300 is determined based on coding information of the current video block.

In some embodiments, the coding information comprises at least one of: a coding tool, a block size of the current video block, a color format of the current video block, a single or dual tree partitioning of the current video block, a color component of the current video block, a slice type of the current video block, or a picture type of the current video block.

In some embodiments, whether a first syntax element associated with the method is included in the bitstream is based on a second syntax element.

In some embodiments, the first syntax element comprises at least one of: an index of a motion shift prediction (MSP), a distance index of a motion shift difference (MSD), or a direction index of the MSD.

According to further embodiments of the present disclosure, a non-transitory computer-readable recording medium is provided. The non-transitory computer-readable recording medium stores a bitstream of a video which is generated by a method performed by an apparatus for video processing. In the method, a motion shift (MS) of a current video block of the video is determined based on at least one indication in the bitstream. The MS comprises a vector associated with a location of a prediction of the current video block. Temporal motion information of the current video block is determined based on the MS. The bitstream is generated based on the temporal motion information.

According to still further embodiments of the present disclosure, a method for storing bitstream of a video is provided. In the method, a motion shift (MS) of a current video block of the video is determined based on at least one indication in the bitstream. The MS comprises a vector associated with a location of a prediction of the current video block. Temporal motion information of the current video block is determined based on the MS. The bitstream is generated based on the temporal motion information. The bitstream is stored in a non-transitory computer-readable recording medium.

Implementations of the present disclosure can be described in view of the following clauses, the features of which can be combined in any reasonable manner.

Clause 1. A method for video processing, comprising: determining, for a conversion between a current video block of a video and a bitstream of the video, a motion shift (MS) of the current video block based on at least one indication in the bitstream, the MS comprising a vector associated with a location of a prediction of the current video block; determining temporal motion information of the current video block based on the MS; and performing the conversion based on the temporal motion information.

Clause 2. The method of clause 1, wherein determining the MS comprises: determining a motion shift prediction (MSP) and a motion shift difference (MSD) of the current video block based on the at least one indication; and determining the MS based on the MSP and the MSD.

Clause 3. The method of clause 2, wherein the at least one indication comprises an indication of the MSD, the MSD being a difference between the MS and a predictor of the MS.

Clause 4. The method of clause 3, wherein the indication of the MSD is included in the bitstream based on one of: an integer-pel precision, or a fractional precision.

Clause 5. The method of any of clauses 2-4, wherein at least one of: a temporal motion vector prediction (TMVP) or a subblock-based TMVP (SbTMVP) is applied to the current video block, and the MS is determined by refining the MSP with the MSD, the MS comprising a motion vector (MV) to locate a location of a TMVP or an SbTMVP of the current video block.

Clause 6. The method of any of clauses 2-5, wherein the at least one indication comprises at least one index indicating the MSD.

Clause 7. The method of clause 6, wherein the MSD is selected from an MSD set based on the at least one index, the MSD set comprising at least one MSD candidate.

Clause 8. The method of clause 7, wherein a candidate in the MSD set is associated with at least one of: a distance index or a direction index.

Clause 9. The method of clause 8, wherein the distance index of the candidate comprises motion magnitude information of the candidate and indicates an offset from the MSP.

Clause 10. The method of clause 9, wherein the offset is added to at least one of: a horizontal component of the MSP, or a vertical component of the MSP.

Clause 11. The method of clause 8, wherein the direction index indicates a direction of the candidate of the MSD relative to a starting point corresponding to the MSP.

Clause 12. The method of clause 8, wherein the direction index indicates at least one direction in a plurality of directions.

Clause 13. The method of any of clauses 7-12, wherein the MSD set comprises a plurality of MSD candidates with a plurality of indexes, the plurality of indexes being reordered based on template matching costs, the plurality of indexes being a plurality of distance indexed or a plurality of direction indexes.

Clause 14. The method of any of clauses 1-13, wherein determining the MS comprises: determining a plurality of motion shift difference (MSD) candidates of the current video block; determining an MSD based on the plurality of MSD candidates; and determining the MS based on the MSD.

Clause 15. The method of clause 14, wherein the at least one indication comprises an index of a target MSD candidate in the plurality of MSD candidates, the MSD being determined based on the target MSD candidate.

Clause 16. The method of clause 15, wherein the MSD is the target MSD candidate.

Clause 17. The method of clause 15, wherein the MSD is determined by applying at least one of a shifting or a scaling to the target MSD candidate.

Clause 18. The method of any of clauses 15-17, wherein the MS is determined based on the MSD and a predictor of the MS.

Clause 19. The method of clause 18, wherein the predictor of the MS is determined during the conversion.

Clause 20. The method of clause 18, wherein the predictor of the MS is defined.

Clause 21. The method of clause 18, wherein the predictor of the MS is included in the bitstream.

Clause 22. The method of any of clauses 1-13, wherein the at least one indication comprises an index of an MS candidate, and determining the MS based on the at least one indication comprises: determining the MS from a plurality of MS candidates based on the index.

Clause 23. The method of clause 22, wherein the MS for the current video block is the MS candidate associated with the index.

Clause 24. The method of clause 22, wherein the MS for the current video block is determined by applying at least one of a shifting or a scaling to the MS candidate associated with the index.

Clause 25. The method of any of clauses 1-13, wherein determining the MS comprises: determining a plurality of motion shift prediction (MSP) candidates of the current video block; determining an MSP based on the plurality of MSP candidates; and determining the MS based on the MSP.

Clause 26. The method of clause 25, wherein the at least one indication comprises an index of a target MSP candidate in the plurality of MSP candidates, the MSP being determined based on the target MSP candidate.

Clause 27. The method of clause 26, wherein the MSP is the target MSP candidate.

Clause 28. The method of clause 26, wherein the MSP is determined by applying at least one of a shifting or a scaling to the target MSP candidate.

Clause 29. The method of any of clauses 26-28, wherein the MS is determined based on the MSP and a motion shift difference (MSD).

Clause 30. The method of clause 29, wherein the MSD is determined during the conversion.

Clause 31. The method of clause 29, wherein the MSD is defined.

Clause 32. The method of clause 29, wherein the MSD is included in the bitstream.

Clause 33. The method of any of clauses 1-32, wherein a history table of stored motion shift predictions (MSPs) of at least one previously coded block of the video is maintained.

Clause 34. The method of any of clauses 1-33, wherein a history table of stored motion shift predictions (MSPs) of at least one previously coded block of the video is updated on-the-fly.

Clause 35. The method of any of clauses 1-34, further comprising: determining at least one motion shift prediction (MSP) list comprising at least one MSP candidate, the MS of the current video block being determined based on the at least one MSP list.

Clause 36. The method of clause 35, wherein an MSP candidate in the at least one MSP list comprises a vector associated with a location, the vector being collected from at least one of: an adjacent location of the current video block, or a non-adjacent location of the current video block.

Clause 37. The method of clause 36, wherein the vector comprises one of: a motion vector (MV) or a block vector (BV).

Clause 38. The method of clause 36, wherein the MSP candidate is collected from a history-based motion vector prediction (HMVP) of the current video block.

Clause 39. The method of any of clauses 35-38, wherein a plurality of MSP candidates is checked in a predefined order to be included in an MSP list of the at least one MSP list.

Clause 40. The method of clause 39, wherein an adjacent candidate is checked before a non-adjacent candidate.

Clause 41. The method of clause 39, wherein the predefined order is based on distances relative to corresponding locations of the MSP candidates.

Clause 42. The method of clause 41, wherein a location with a corresponding location less than a current location of the current video block has a priority higher than a threshold priority.

Clause 43. The method of any of clauses 39-42, wherein the checking terminates if the number of available candidates in the MSP candidate list reaches a threshold number.

Clause 44. The method of any of clauses 35-43, wherein the at least one MSP list comprises a plurality of MSP lists.

Clause 45. The method of clause 44, wherein the plurality of MSP lists comprises a respective MSP list for each of at least one reference picture list.

Clause 46. The method of clause 44, wherein the plurality of MSP lists comprises at least one MSP list for at least one reference picture, the temporal motion information of the current video block being determined based on the at least one reference picture.

Clause 47. The method of clause 46, wherein the at least one reference picture corresponds to at least one collocated picture of the current video block.

Clause 48. The method of clause 46 or 47, wherein the at least one reference picture comprises a plurality of reference pictures, and the plurality of MSP lists comprises respective MSP lists of the plurality of reference pictures.

Clause 49. The method of clause 46 or 47, wherein the at least one reference picture comprises a plurality of reference pictures corresponding to a plurality of collocated pictures of the current video block, and the plurality of MSP lists comprises at least one MSP list associated with at least one collocated picture of the plurality of collocated pictures.

Clause 50. The method of any of clauses 44-49, wherein for a collocated picture of a plurality of collocated pictures of the current video block, an MSP list corresponding to the collocated picture comprises at least one MSP pointing to the collocated picture.

Clause 51. The method of clause 50, wherein an MSP does not point to the collocated picture, a scaled MSP scaling from the MSP is included in the MSP list if the scaled MSP points to the collocated picture.

Clause 52. The method of any of clauses 35-43, wherein the at least one MSP list comprises a single MSP list, at least one MSP candidate pointing to one of a plurality of collocated pictures of the current video block is included in the single MSP list.

Clause 53. The method of any of clauses 35-52, wherein the at least one MSP list is determined based on at least one of: a merge candidate list, or an advanced motion vector prediction (AMVP) candidate list.

Clause 54. The method of clause 53, wherein candidates in at least one of the merge candidate list or the AMVP candidate list are checked in order based on at least one condition.

Clause 55. The method of clause 54, wherein the at least one condition comprises a condition that a candidate points to at least one collocated picture of the current video block, and if the condition is satisfied, the candidate is included in the at least one MSP list.

Clause 56. The method of any of clauses 35-55, wherein the at least one MSP list is determined based on a pruning process.

Clause 57. The method of any of clauses 35-56, wherein the number of candidates in an MSP list of the at least one MSP list is fixed.

Clause 58. The method of clause 57, wherein after checking at least one of: an adjacent candidate, a non-adjacent candidate or a history-based motion vector prediction (HMVP) candidate, if the number of available candidates in the MSP list is less than the fixed number, at least one virtual candidate is included to pad the MSP list.

Clause 59. The method of clause 58, wherein the at least one virtual candidate comprises at least one of: a zero candidate, or a further candidate.

Clause 60. The method of any of clauses 35-59, wherein the at least one MSP list is reordered based on a cost.

Clause 61. The method of clause 60, wherein the cost comprises a template matching cost.

Clause 62. The method of any of clauses 1-61, wherein the at least one indication comprises an index of a motion shift prediction (MSP) in an MSP list, the MS of the current video block being determined based on the MSP associated with the index.

Clause 63. The method of any of clauses 1-61, wherein an index of a motion shift prediction (MSP) in an MSP list is not included in the bitstream.

Clause 64. The method of clause 63, wherein an MSP is determined based on a motion vector in a fixed location, the MS of the current video block being determined based on the MSP.

Clause 65. The method of clause 64, wherein if the motion vector in the fixed location is unavailable or does not satisfy a condition, the MSP is determined to be a zero motion vector.

Clause 66. The method of clause 64, wherein the MSP is determined by scaling the motion vector.

Clause 67. The method of clause 63, wherein the MS of the current video block is determined based on an MSP, the MSP being determined by checking at least one of: a motion vector in an adjacent candidate, a motion vector in a non-adjacent candidate, a history-based motion vector prediction (HMVP), a candidate in a merge candidate list, or a candidate in an advanced motion vector prediction (AMVP) candidate list.

Clause 68. The method of clause 67, wherein a first candidate satisfying at least one condition during the checking is determined as the MSP.

Clause 69. The method of clause 67, wherein no candidate satisfies at least one condition during the checking, and the MSP is determined to be a zero motion vector.

Clause 70. The method of any of clauses 1-69, wherein a motion shift prediction (MSP) candidate list of the current video block comprises at least one of: a merge candidate list, a subblock-based merge candidate list, or an advanced motion vector prediction (AMVP) candidate list.

Clause 71. The method of any of clauses 1-69, wherein a motion shift difference (MSD) candidate list of the current video block comprises at least one of: a merge candidate list, a subblock-based merge candidate list, or an advanced motion vector prediction (AMVP) candidate list.

Clause 72. The method of any of clauses 1-71, wherein whether an indication of a motion shift difference (MSD) is included in the bitstream is based on a coding mode of the current video block.

Clause 73. The method of clause 72, wherein the indication of the MSD comprises at least one of: a distance index of the MSD, or a direction index of the MSD.

Clause 74. The method of clause 72 or 73, wherein the coding mode comprises at least one of: a merge mode or an advanced motion vector prediction (AMVP) mode, and the indication of the MSD is included in the bitstream.

Clause 75. The method of any of clauses 72-74, wherein the indication of the MSD is included in the bitstream, and a motion vector difference (MVD) is not included in the bitstream.

Clause 76. The method of clause 72, wherein a motion vector difference (MVD) is included in the bitstream, and the indication of the MSD is not included in the bitstream.

Clause 77. The method of clause 72, wherein a motion vector difference (MVD) and the indication of the MSD are included in the bitstream simultaneously for the current video block.

Clause 78. The method of any of clauses 1-77, further comprising: determining a list of MS candidates for the current video block, wherein a first MS candidate is added into the list of MS candidates based on a comparison with a second MS candidate.

Clause 79. The method of clause 78, wherein if a difference between the first MS candidate and the second MS candidate is less than or equal to a threshold, the first MS candidate is not added into the list of MS candidates.

Clause 80. The method of clause 79, wherein if a difference between first motion information in a first block referred by the first MS candidate and second motion information in a second block referred by the second MS candidate is less than or equal to a threshold, the first MS candidate is not added into the list of MS candidates.

Clause 81. The method of any of clauses 1-80, wherein the at least one indication in the bitstream is coded by at least one of: a truncated rice (TR) code, a truncated binary (TB) code, a k-th order exponential-Golomb (EGk) code, or a fixed-length (FL) code, wherein the at least one indication comprises at least one of: an index of a motion shift prediction (MSP) of the current video block, or an index of a motion shift difference (MSD) of the current video block.

Clause 82. The method of any of clauses 1-81, wherein the method is applied to at least one of: a temporal motion vector prediction (TMVP), a subblock-based TMVP (SbTMVP), or a temporal motion information derivation, and wherein the vector comprised in the MS comprises a motion vector.

Clause 83. The method of any of clauses 1-81, wherein the method is applied to at least one of: an intra block copy (IBC) merge mode, or an IBC advanced motion vector prediction (AMVP) mode, and wherein the vector comprised in the MS comprises a block vector.

Clause 84. The method of any of clauses 1-83, wherein whether to and/or how to apply the method is based on at least one syntax element.

Clause 85. The method of clause 84, wherein the at least one syntax element is included in the bitstream.

Clause 86. The method of clause 85, wherein the at least one syntax element is included at at least one of: a sequence level, a group of pictures level, a picture level, a slice level, or a tile group level.

Clause 87. The method of clause 85 or 86, wherein the at least one syntax element is included in at least one of: a sequence header, a picture header, a sequence parameter set (SPS), a video parameter set (VPS), a decoded parameter set (DPS), decoding capability information (DCI), a picture parameter set (PPS), an adaptation parameter set (APS), a slice header, or a time group header.

Clause 88. The method of any of clauses 85-87, wherein the at least one syntax element is included in a region containing more than one sample or pixel.

Clause 89. The method of clause 88, wherein the region comprises at least one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, or a subpicture.

Clause 90. The method of any of clauses 1-83, wherein whether to and/or how to apply the method is determined based on coding information of the current video block.

Clause 91. The method of clause 90, wherein the coding information comprises at least one of: a coding tool, a block size of the current video block, a color format of the current video block, a single or dual tree partitioning of the current video block, a color component of the current video block, a slice type of the current video block, or a picture type of the current video block.

Clause 92. The method of any of clauses 1-91, wherein whether a first syntax element associated with the method is included in the bitstream is based on a second syntax element.

Clause 93. The method of clause 92, wherein the first syntax element comprises at least one of: an index of a motion shift prediction (MSP), a distance index of a motion shift difference (MSD), or a direction index of the MSD.

Clause 94. The method of any of clauses 1-93, wherein the conversion comprises encoding the current video block into the bitstream.

Clause 95. The method of any of clauses 1-93, wherein the conversion comprises decoding the current video block from the bitstream.

Clause 96. An apparatus for video processing comprising a processor and a non-transitory memory with instructions thereon, wherein the instructions upon execution by the processor, cause the processor to perform a method in accordance with any of clauses 1-95.

Clause 97. A non-transitory computer-readable storage medium storing instructions that cause a processor to perform a method in accordance with any of clauses 1-95.

Clause 98. A non-transitory computer-readable recording medium storing a bitstream of a video which is generated by a method performed by an apparatus for video processing, wherein the method comprises: determining a motion shift (MS) of a current video block of the video based on at least one indication in the bitstream, the MS comprising a vector associated with a location of a prediction of the current video block; determining temporal motion information of the current video block based on the MS; and generating the bitstream based on the temporal motion information.

Clause 99. A method for storing a bitstream of a video, comprising: determining a motion shift (MS) of a current video block of the video based on at least one indication in the bitstream, the MS comprising a vector associated with a location of a prediction of the current video block; determining temporal motion information of the current video block based on the MS; generating the bitstream based on the temporal motion information; and storing the bitstream in a non-transitory computer-readable recording medium.

### Example Device

FIG. 14 illustrates a block diagram of a computing device 1400 in which various embodiments of the present disclosure can be implemented. The computing device 1400 may be implemented as or included in the source device 110 (or the video encoder 114 or 200) or the destination device 120 (or the video decoder 124 or 300).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement video encoding/decoding in embodiments of the present disclosure. The memory 1420 may include one or more video coding modules 1425 having one or more program instructions. These modules are accessible and executable by the processing unit 1410 to perform the functionalities of the various embodiments described herein.

In the example embodiments of performing video encoding, the input device 1450 may receive video data as an input 1470 to be encoded. The video data may be processed, for example, by the video coding module 1425, to generate an encoded bitstream. The encoded bitstream may be provided via the output device 1460 as an output 1480.

In the example embodiments of performing video decoding, the input device 1450 may receive an encoded bitstream as the input 1470. The encoded bitstream may be processed, for example, by the video coding module 1425, to generate decoded video data. The decoded video data may be provided via the output device 1460 as the output 1480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for video processing, comprising:
determining, for a conversion between a current video block of a video and a bitstream of the video, a motion shift (MS) of the current video block based on at least one indication in the bitstream, the MS comprising a vector associated with a location of a prediction of the current video block;
determining temporal motion information of the current video block based on the MS; and
performing the conversion based on the temporal motion information.

2. The method of claim 1, wherein determining the MS comprises:
determining a motion shift prediction (MSP) and a motion shift difference (MSD) of the current video block based on the at least one indication; and
determining the MS based on the MSP and the MSD,
wherein the at least one indication comprises an indication of the MSD, the MSD being a difference between the MS and a predictor of the MS, and/or
wherein the indication of the MSD is included in the bitstream based on one of: an integer-pel precision, or a fractional precision.

3. The method of claim 2, wherein at least one of: a temporal motion vector prediction (TMVP) or a subblock-based TMVP (SbTMVP) is applied to the current video block, and the MS is determined by refining the MSP with the MSD, the MS comprising a motion vector (MV) to locate a location of a TMVP or an SbTMVP of the current video block, and/or
wherein the at least one indication comprises at least one index indicating the MSD,
wherein the MSD is selected from an MSD set based on the at least one index, the MSD set comprising at least one MSD candidate,
wherein a candidate in the MSD set is associated with at least one of: a distance index or a direction index, and/or
wherein the MSD set comprises a plurality of MSD candidates with a plurality of indexes, the plurality of indexes being reordered based on template matching costs, the plurality of indexes being a plurality of distance indexed or a plurality of direction indexes.

4. The method of claim 3, wherein the distance index of the candidate comprises motion magnitude information of the candidate and indicates an offset from the MSP, wherein the offset is added to at least one of: a horizontal component of the MSP, or a vertical component of the MSP, or
wherein the direction index indicates a direction of the candidate of the MSD relative to a starting point corresponding to the MSP, or
wherein the direction index indicates at least one direction in a plurality of directions.

5. The method of claim 1, wherein determining the MS comprises:
determining a plurality of motion shift difference (MSD) candidates of the current video block;
determining an MSD based on the plurality of MSD candidates; and
determining the MS based on the MSD,
wherein the at least one indication comprises an index of a target MSD candidate in the plurality of MSD candidates, the MSD being determined based on the target MSD candidate,
wherein the MSD is the target MSD candidate, or wherein the MSD is determined by applying at least one of a shifting or a scaling to the target MSD candidate,
wherein the MS is determined based on the MSD and a predictor of the MS.

6. The method of claim 1, wherein determining the MS comprises:
determining a plurality of motion shift prediction (MSP) candidates of the current video block;
determining an MSP based on the plurality of MSP candidates; and
determining the MS based on the MSP,
wherein the at least one indication comprises an index of a target MSP candidate in the plurality of MSP candidates, the MSP being determined based on the target MSP candidate,
wherein the MSP is the target MSP candidate, or wherein the MSP is determined by applying at least one of a shifting or a scaling to the target MSP candidate.

7. The method of claim 6, wherein the MS is determined based on the MSP and a motion shift difference (MSD),
wherein the MSD is determined during the conversion, or
wherein the MSD is defined, or
wherein the MSD is included in the bitstream.

8. The method of claim 1, wherein a history table of stored motion shift predictions (MSPs) of at least one previously coded block of the video is maintained, and/or
wherein a history table of stored motion shift predictions (MSPs) of at least one previously coded block of the video is updated on-the-fly.

9. The method of claim 1, further comprising:
determining at least one motion shift prediction (MSP) list comprising at least one MSP candidate, the MS of the current video block being determined based on the at least one MSP list,
wherein an MSP candidate in the at least one MSP list comprises a vector associated with a location, the vector being collected from at least one of: an adjacent location of the current video block, or a non-adjacent location of the current video block,
wherein the vector comprises one of: a motion vector (MV) or a block vector (BV), or wherein the MSP candidate is collected from a history-based motion vector prediction (HMVP) of the current video block,
wherein a plurality of MSP candidates is checked in a predefined order to be included in an MSP list of the at least one MSP list,
wherein an adjacent candidate is checked before a non-adjacent candidate, or
wherein the predefined order is based on distances relative to corresponding locations of the MSP candidates, wherein a location with a corresponding location less than a current location of the current video block has a priority higher than a threshold priority,
wherein the checking terminates if the number of available candidates in the MSP candidate list reaches a threshold number.

10. The method of claim 9, wherein the at least one MSP list comprises a plurality of MSP lists, wherein for a collocated picture of a plurality of collocated pictures of the current video block, an MSP list corresponding to the collocated picture comprises at least one MSP pointing to the collocated picture, wherein an MSP does not point to the collocated picture, a scaled MSP scaling from the MSP is included in the MSP list if the scaled MSP points to the collocated picture, or
wherein the at least one MSP list is determined based on at least one of: a merge candidate list, or an advanced motion vector prediction (AMVP) candidate list, wherein candidates in at least one of the merge candidate list or the AMVP candidate list are checked in order based on at least one condition, wherein the at least one condition comprises a condition that a candidate points to at least one collocated picture of the current video block, and if the condition is satisfied, the candidate is included in the at least one MSP list, or
wherein the at least one MSP list is determined based on a pruning process, and/or
wherein the number of candidates in an MSP list of the at least one MSP list is fixed, wherein after checking at least one of: an adjacent candidate, a non-adjacent candidate or a history-based motion vector prediction (HMVP) candidate, if the number of available candidates in the MSP list is less than the fixed number, at least one virtual candidate is included to pad the MSP list, wherein the at least one virtual candidate comprises at least one of: a zero candidate, or a further candidate.

11. The method of claim 1, wherein the at least one indication comprises an index of a motion shift prediction (MSP) in an MSP list, the MS of the current video block being determined based on the MSP associated with the index, or
wherein an index of a motion shift prediction (MSP) in an MSP list is not included in the bitstream, wherein an MSP is determined based on a motion vector in a fixed location, the MS of the current video block being determined based on the MSP,
wherein if the motion vector in the fixed location is unavailable or does not satisfy a condition, the MSP is determined to be a zero motion vector, or wherein the MSP is determined by scaling the motion vector,
wherein the MS of the current video block is determined based on an MSP, the MSP being determined by checking at least one of: a motion vector in an adjacent candidate, a motion vector in a non-adjacent candidate, a history-based motion vector prediction (HMVP), a candidate in a merge candidate list, or a candidate in an advanced motion vector prediction (AMVP) candidate list,
wherein a first candidate satisfying at least one condition during the checking is determined as the MSP, or wherein no candidate satisfies at least one condition during the checking, and the MSP is determined to be a zero motion vector.

12. The method of claim 1, wherein a motion shift prediction (MSP) candidate list of the current video block comprises at least one of: a subblock-based merge candidate list, or an advanced motion vector prediction (AMVP) candidate list, or
wherein a motion shift difference (MSD) candidate list of the current video block comprises at least one of: a subblock-based merge candidate list, or an advanced motion vector prediction (AMVP) candidate list.

13. The method of claim 1, wherein whether an indication of a motion shift difference (MSD) is included in the bitstream is based on a coding mode of the current video block,
wherein the indication of the MSD comprises at least one of: a distance index of the MSD, or a direction index of the MSD,
wherein the coding mode comprises an advanced motion vector prediction (AMVP) mode, and the indication of the MSD is included in the bitstream, and/or
wherein the indication of the MSD is included in the bitstream, and a motion vector difference (MVD) is not included in the bitstream.

14. The method of claim 1, further comprising:
determining a list of MS candidates for the current video block, wherein a first MS candidate is added into the list of MS candidates based on a comparison with a second MS candidate,
wherein if a difference between the first MS candidate and the second MS candidate is less than or equal to a threshold, the first MS candidate is not added into the list of MS candidates,
wherein if a difference between first motion information in a first block referred by the first MS candidate and second motion information in a second block referred by the second MS candidate is less than or equal to a threshold, the first MS candidate is not added into the list of MS candidates.

15. The method of claim 1, wherein the at least one indication in the bitstream is coded by at least one of: a truncated rice (TR) code, a truncated binary (TB) code, a k-th order exponential-Golomb (EGk) code, or a fixed-length (FL) code,
wherein the at least one indication comprises at least one of: an index of a motion shift prediction (MSP) of the current video block, or an index of a motion shift difference (MSD) of the current video block.

16. The method of claim 1, wherein the method is applied to at least one of: a temporal motion vector prediction (TMVP), a subblock-based TMVP (SbTMVP), or a temporal motion information derivation, and wherein the vector comprised in the MS comprises a motion vector, or
wherein the method is applied to at least one of: an intra block copy (IBC) merge mode, or an IBC advanced motion vector prediction (AMVP) mode, and wherein the vector comprised in the MS comprises a block vector.

17. The method of claim 1, wherein the conversion comprises encoding the current video block into the bitstream, or
wherein the conversion comprises decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, a motion shift (MS) of the current video block based on at least one indication in the bitstream, the MS comprising a vector associated with a location of a prediction of the current video block;
determine temporal motion information of the current video block based on the MS; and
perform the conversion based on the temporal motion information.

19. A non-transitory computer-readable storage medium storing instructions that cause a processor to perform a method comprising:
determining, for a conversion between a current video block of a video and a bitstream of the video, a motion shift (MS) of the current video block based on at least one indication in the bitstream, the MS comprising a vector associated with a location of a prediction of the current video block;
determining temporal motion information of the current video block based on the MS; and
performing the conversion based on the temporal motion information.

20. A non-transitory computer-readable recording medium storing a bitstream of a video which is generated by a method performed by an apparatus for video processing, wherein the method comprises:
determining a motion shift (MS) of a current video block of the video based on at least one indication in the bitstream, the MS comprising a vector associated with a location of a prediction of the current video block;
determining temporal motion information of the current video block based on the MS; and
generating the bitstream based on the temporal motion information.
